(19) United States
(12) Patent Application Publication
(10) Pub. No.: US 2007/0164179 A1
(43) Pub. Date: Jul. 19, 2007

(54) Apparatus providing both structural support and electrical conductor connection for a lighting fixture

(76) Inventor: Ryan Rice, Auburn, IN (US)

Correspondence Address: TAYLOR & AUST, P.C., 142 SOUTH MAIN STREET, P. O. BOX 560, AVILLA, IN, 46710, US

(21) Appl. No.: 11/542,886

(22) Filed: Oct. 4, 2006

Related U.S. Application Data
(60) Provisional application No. 60/723,794, filed on Oct. 5, 2005.

(51) Int. Cl. F16M 11/00

(52) U.S. Cl. 248/200

(57) ABSTRACT

The invention in one form is directed to a mechanical and electrical coupling assembly for a light fixture, the coupling assembly including a first bracket configured for coupling with an end of a support arm, a first electrical connector mounted to the first bracket, a second bracket mechanically coupled with the first bracket, and a second electrical connector mounted to the second bracket, the second electrical connector being directly electrically coupled with the first electrical connector. The first bracket can be a vertical arm bracket, and the second bracket can be a wireway bracket. Alternatively, the first bracket can be a hanger cap, and the second bracket can be a reflector cap.

### CROSS REFERENCE TO RELATED APPLICATIONS

This is a non-provisional application based upon U.S. provisional patent application Ser. no. 60/723,794, entitled “METHOD AND APPARATUS PROVIDING BOTH STRUCTURAL SUPPORT AND ELECTRICAL CONDUCTOR CONNECTION FOR A LIGHTING FIXTURE”, filed Oct. 5, 2005.

### BACKGROUND OF THE INVENTION

1. Field of the Invention

The present invention relates to light fixtures, and, more particularly, to coupling assemblies providing both structural support and electrical conductor connection for a light fixture.

2. Description of the Related Art

Light fixtures such as fluorescent lights, etc., are often used for task lighting or accent lighting. They can include hangers and associated coupling assemblies.

Various techniques are used in coupling hanger parts together and/or hangers with other parts of the light fixture. For instance, one technique includes mounting an arm to a pintle by a bearing sleeve hinged to and turnable about the pintle, the arm being connected to a lamp. Another technique includes a cross-shaped tube connector having nipples over which two horizontal arms connect via pins, the arms being connected at their distal ends to lighting elements. Yet another technique includes connecting a vertical arm of a hanger to a single crossbar arm of the hanger using a screw through the bottom of the crossbar arm. Yet another technique includes routing free electrical connectors from the upper end of a vertical arm of a hanger, through brackets, and into a ballast box where the free electrical connectors couple with other electrical connectors running from a ballast. Yet another technique includes routing a free electrical connector from a distal end of a crossbar arm of a hanger through an endplate to another free electrical connector, the latter free electrical connector being electrically connected to a lamp socket by wires which are connected to the endplate.

Such techniques, however, pose certain disadvantages. First, generally the assembly of such hangers and coupling assemblies can be, at least in part, slow, labor-intensive, and difficult. Second, feeding wires through such hangers can be difficult. Second, coupling parts with pins requires manufacturing pins, as well as parts having aligned pinholes. Third, electrical connection is not made when hanger end brackets are placed into their respective operating positions, thus requiring the additional step of making the electrical connections.

What is needed in the art is an apparatus which provides coupling assemblies providing quick installation of a hanger of a light fixture and providing virtually simultaneous structural support and electrical conductor connection for the light fixture.

### SUMMARY OF THE INVENTION

The present invention provides an apparatus which provides coupling assemblies providing quick installation of a hanger of a light fixture and providing virtually simultaneous structural support and electrical conductor connection for the light fixture.

The invention in one form is directed to a mechanical and electrical coupling assembly for a light fixture, the coupling assembly including a first bracket configured for coupling with an end of a support arm, a first electrical connector mounted to the first bracket, a second bracket mechanically coupled with the first bracket, and a second electrical connector mounted to the second bracket, the second electrical connector being directly electrically coupled with the first electrical connector. The first bracket can be a vertical arm bracket, and the second bracket can be a wireway bracket. Alternatively, the first bracket can be a hanger cap, and the second bracket can be a reflector cap.

The invention in another form is directed to a wireway coupling assembly of a light fixture having a vertical arm, the wireway coupling assembly including a vertical arm bracket configured for coupling with the vertical arm, a first electrical connector mounted to the vertical arm bracket, a wireway bracket mechanically coupled with the vertical arm bracket, and a second electrical connector mounted to the wireway bracket, the second electrical connector being directly electrically coupled with the first electrical connector.

The invention in another form is directed to a reflector coupling assembly for a light fixture having a reflector and a lampholder, the reflector coupling assembly including a reflector cap configured for coupling with the reflector and/or the lampholder, a hanger cap coupled with the reflector cap, the hanger cap being configured for coupling with an end of a base arm, at least one reflector cap electrical connector mounted to the reflector cap, and at least one hanger cap electrical connector mounted to the hanger cap, each hanger cap electrical connector being directly electrically coupled with a corresponding reflector cap electrical connector.

The invention in another form is directed to a hanger coupling assembly for a light fixture, the hanger coupling assembly including a vertical arm having a lower end, a pair of base arms each having a proximal end, and a coupler including a neck and a base. The base has two ends. The neck is frictionally coupled with the lower end of the vertical arm, and each end of the base is frictionally coupled with a corresponding base arm proximal end.

An advantage of the present invention is that it provides for ease of assembly and disassembly of the light fixture.

Another advantage is that the present invention provides electrical “quick connects” to be used during assembly of the light fixture.

Yet another advantage is that mechanical and electrical coupling during assembly of at least parts of the light fixture can occur virtually simultaneously.

Yet another advantage is that wiring through an inverted T-hanger is easier.

Yet another advantage is that a T-hanger including two pieces for a crossing section can be easier to store, ship, and handle.

Yet another advantage is that the light fixture is more structurally sound at the area of the hanger coupling assembly.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a partially exploded, perspective view of an embodiment of a linear light without a reflector cap according to the present invention;

FIG. 2 is an enlarged, partial, perspective view of an embodiment of a wireway coupling assembly shown in FIG. 1 according to the present invention;

FIG. 3 is an enlarged, partial, perspective view of a reflector coupling assembly shown in FIG. 1 without a reflector cap;

FIG. 4 is an exploded, perspective view of an embodiment of a hanger coupling assembly according to the present invention;

FIG. 5 is a fragmentary, exploded, side view of an embodiment of the hanger coupling assembly according to the present invention;

FIG. 6 is a fragmentary, cross-sectional side view of an embodiment of the hanger coupling assembly according to the present invention taken along line Y-Y of FIG. 4;

FIG. 7 is a partially exploded, perspective view of an embodiment of the wireway coupling assembly according to the present invention;

FIG. 8 is a partially exploded, perspective view of an embodiment of the reflector coupling assembly according to the present invention; and

FIG. 9 is a perspective view of an embodiment of a reflector cap and a hanger cap of the reflector coupling assembly according to the present invention.

Corresponding reference characters indicate corresponding parts throughout the several views. The exemplifications set out herein illustrate embodiments of the invention, in one form, and such exemplifications are not to be construed as limiting the scope of the invention in any manner.

### DETAILED DESCRIPTION OF THE INVENTION

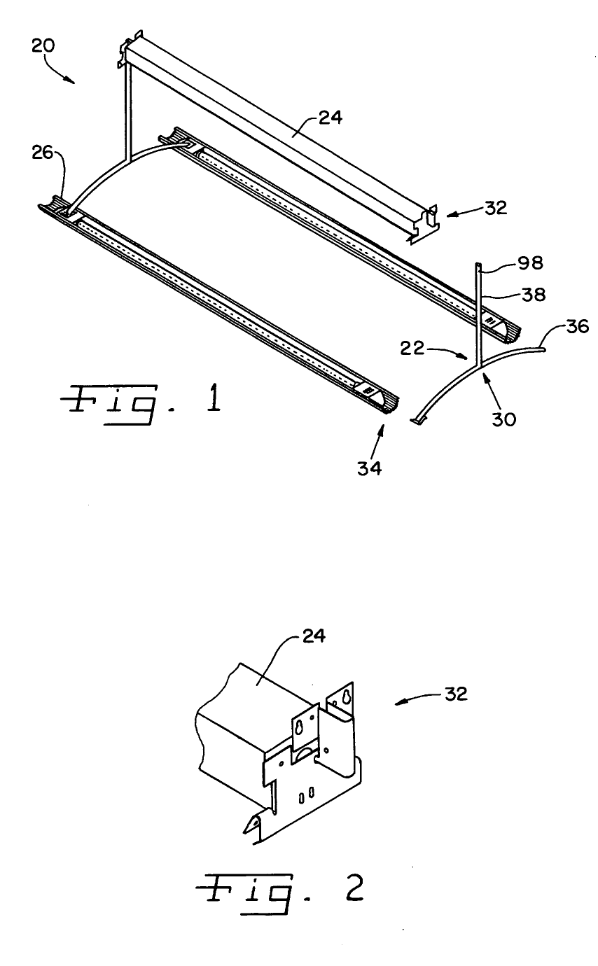

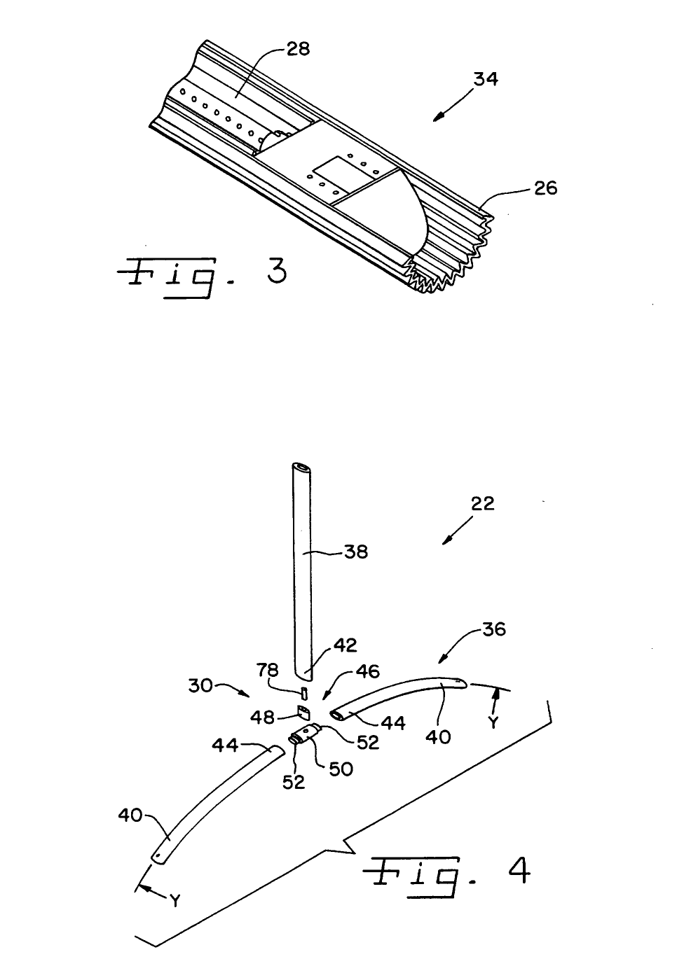

Referring now to the drawings, and more particularly to FIGS. 1, 2, and 3, there is shown a linear light fixture 20 which generally includes a hanger 22, a wireway 24, a reflector 26, and a lampholder 28. Hanger 22 includes a hanger coupling assembly 30, a wireway coupling assembly 32, and a reflector coupling assembly 34 (reflector cap 134 is not shown in FIGS. 1 and 3). On each side of wireway 24, conductors (not shown), which are interspersed by electrical connectors, generally run from wireway 24, through wireway coupling assembly 32, through hanger 22 and hanger coupling assembly 30, through reflector coupling assembly 34, and to a lamp (not shown).

When assembled, hanger 22 has a generally inverted T-shape and includes a crossing section 36 and a vertical arm 38. Crossing section 36 of the inverted “T” is generally horizontal or arcs in a downward direction. Crossing section 36 includes two base arms 40. Vertical arm 38 and base arms 40 are indirectly coupled relative to one another by hanger coupling assembly 30.

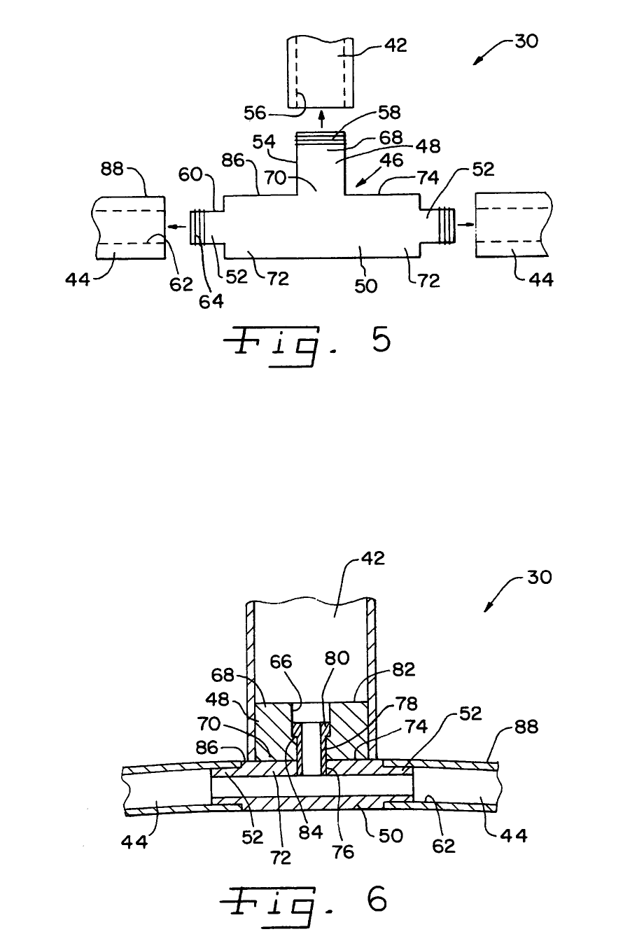

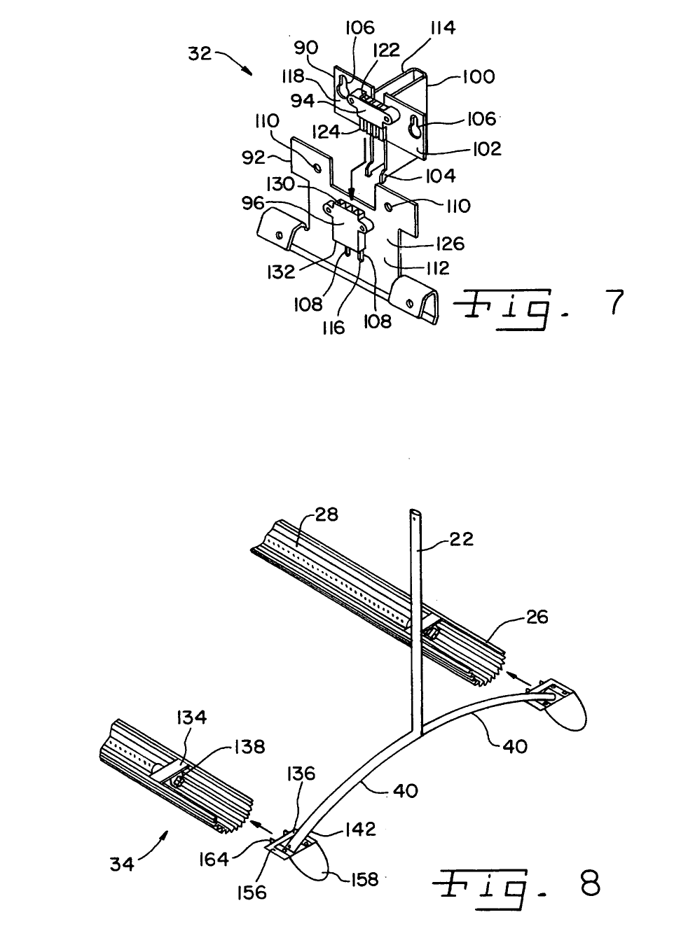

Referring to FIGS. 4-6, hanger coupling assembly 30 includes a lower end 42 of vertical arm 38, proximal ends 44 of each base arm 40, and a T-coupler 46 having a neck 48 and a base 50. T-coupler 46 has a generally inverted T-shape. Neck 48 and base 50 of T-coupler 46 can be formed integral relative to one another, as shown in FIG. 5. Alternatively, neck 48 and base 50 of T-coupler 46 can be separate pieces which are attachable and detachable relative to one anther, as shown in FIGS. 4 and 6. Neck 48 is positioned approximately at a midpoint along a longitudinal axis of base 50. Neck 48 is vertically oriented. Base 50 has two ends 52 and is generally horizontally oriented or downwardly arced. Base arms 40 extend from coupler 46 in a generally horizontal direction or a generally downwardly arced direction. Vertical arm 38, base arms 40, neck 48, and base 50 each have a generally elliptical outer shape and each have inner configurations suitable for carrying conductors. Each base arm 40 is essentially the same size relative to one another. Neck 48 is frictionally coupled with vertical arm lower end 42, and each base end 52 is frictionally coupled with a corresponding base arm proximal end 44. Coupler 46 is positioned at an approximate apex of downwardly arced base arms 40. Base arms 40 extend from coupler 46 in a downwardly arced direction.

Neck 48 couples with vertical arm lower end 42 by inserting neck 48 into vertical arm lower end 42. An outer surface 54 of neck 48 is complementary in shape to an inner surface 56 of vertical arm lower end 42. Inner surface 56 of vertical arm lower end 42 circumsferentially overlaps and surrounds outer surface 54 of neck 48, thus forming an interference fit. To further facilitate this interference fit, neck outer surface 54 can include teeth 58. Teeth 58 can include ribs. Neck 48 and vertical arm lower end 42 are, thus, securely coupled.

Each base end 52 couples with the corresponding base arm proximal end 44 by inserting each base end 52 into the corresponding base arm proximal end 44. An outer surface 60 of each base end 52 is complementary in shape to an inner surface 62 of each corresponding base arm proximal end 44. Inner surface 62 of each base arm proximal end 44 circumferentially overlaps and surrounds outer surface 60 of corresponding base end 52, thus forming an interference fit. To further facilitate this interference fit, each base end outer surface 60 can include teeth 64. Teeth 64 can include ribs. Each base end 52 and each corresponding base arm proximal end 44 are, thus, securely coupled.

In the embodiment shown in FIG. 4, neck 48 and base 50 are separate pieces. As shown in FIG. 6, neck 48 defines a hollow chamber 66 running from a vertical arm end 68 of neck 48 to a base end 70 of neck 48. Base 50 has a middle section 72 including a top surface 74 defining a threaded hole 76 in top surface 74. Neck 48 connects to top surface 74 of middle section 72 of base 50 by a fastener 78 fastened to threaded hole 76 through hollow chamber 66. Fastener 78 can be a screw having a head 80. Screw head 80 can mount on top of a side surface 82 of vertical arm end 68 of neck 48 (not shown). Alternatively, according to the embodiment shown in FIG. 6, hollow chamber 66 includes a shoulder 84. Screw head 80 can, thus, mount on top of hollow chamber shoulder 84. Shoulder 84 can be a counter-board. The interface of screw head 80 and side surface 82 or shoulder 84 prevents screw 78 from passing through hollow chamber 66 when screw 78 is fastened to threaded hole 76. Fastener 78 can be hollow to permit the passage of conductors.

According to the embodiments shown in FIGS. 5-6, base ends 52 have an outer surface 60 radial cross-section, and middle section 72 of base 50 has an outer surface 86 radial cross-section. Each base arm proximal end 44 also has an outer surface 88 radial cross-section. Outer surface 60 radial cross-section of each base end 52 is smaller than outer surface 86 radial cross-section of base middle section 72. Outer surface 86 radial cross-section of base middle section 72 is substantially equivalent in size to outer surface 88 radial cross-section of each base arm proximal end 44. Thus, when each base end 52 is inserted into each corresponding base arm proximal end 44, outer surface 86 of base middle section 72 is essentially flush with outer surface 88 of each base arm proximal end 44.

Referring to FIG. 7, wireway coupling assembly 32 includes a vertical arm bracket 90, a wireway bracket 92, a first electrical connector 94 mounted to vertical arm bracket 90, a second electrical connector 96 mounted to wireway bracket 92. Vertical arm bracket 90 is configured for coupling with an upper end 98 of vertical arm 38, as shown in FIG. 1. Wireway bracket 92 is suitably configured for coupling with a wireway 24 which houses conductors (not shown) running to a ballast (not shown). Vertical arm bracket 90 is mechanically coupled with wireway bracket 92. First electrical connector 94 is directly electrically coupled with second electrical connector 96.

Vertical arm bracket 90 includes a generally U-shaped section 100, a generally flat expanse 102, and two tabs 104 and further defines holes 106. Wireway bracket 92 defines two slots 108 and two holes 110 and has a generally flat expanse 112. U-shaped section 100 secures, at least in part, vertical arm upper end 98 by clamping vertical arm upper end 98 in a suitable manner. Vertical arm upper end 98 can be further secured by vertical arm bracket 90 in a suitable manner. Tabs 104 extend from the bottom of and below legs 114 of U-shaped section 100 and are located on the open end of U-shaped section 100. Tabs 104 form generally curved protrusions which insert into corresponding, complementary-sized slots 108 in wireway bracket 92. Curved protrusions of tabs 104 hook around a bottom tight-radius section 116 of each corresponding slot 108. The interconnection of tabs 104 and slots 108 provide, at least in part, mechanical coupling of vertical arm bracket 90 and wireway bracket 92. Vertical arm bracket holes 106 can form keyholes. Fasteners, such as screws (not shown), can be inserted into vertical arm bracket holes 106, through wireway bracket holes 110, and into threaded holes on wireway (not shown). Thus, vertical arm bracket 90 is mechanically coupled with wireway bracket 92, and both brackets 90, 92 are coupled with wireway 24.

First electrical connector 94 is mounted to vertical arm bracket 90 on a side 118 of vertical arm bracket 90 facing wireway bracket 92. First electrical connector 94 can be riveted to vertical arm bracket 90. First electrical connector 94 includes a set of terminals including a set of male terminals and/or a set of female terminals. In the embodiment shown in FIG. 7, first electrical connector 94 includes a set of female terminals 122 and a set of male terminals 124. Male terminals (not shown) extending from conductors exiting vertical arm upper end 98 mate with set of female terminals 122.

Second electrical connector 96 is mounted to wireway bracket 92 on a side 126 of wireway bracket 92 facing wireway 24 but opposing vertical arm bracket 90. Second electrical connector 96 can be riveted to wireway bracket 92. Second electrical connector 96 includes a set of terminals including a set of male terminals and/or a set of female terminals. In the embodiment shown in FIG. 7, second electrical connector 96 includes a set of female terminals including two subsets of female terminals 130, 132. First subset of female terminals 130 mates with downwardly extending set of male terminals 124 coupled with vertical arm bracket 90. Male terminals (not shown) extending from conductors exiting wireway 24 mate with second subset of female terminals 132 of second electrical connector 96. When first electrical connector 94 and second electrical connector 96 electrically couple with each other, each has an insertion direction generally parallel to each generally flat expanse 102, 112 of vertical arm bracket 90 and wireway bracket 92.

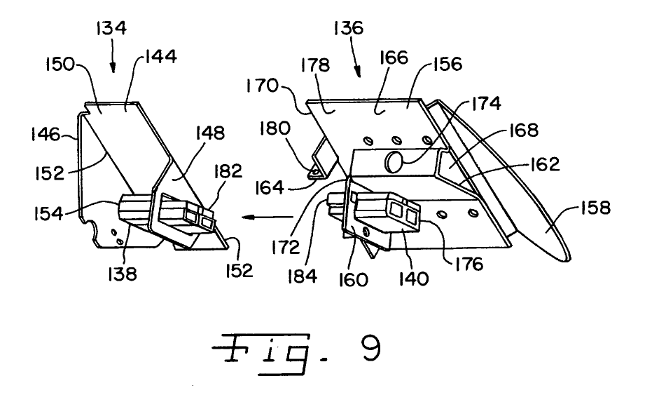

Referring to FIGS. 8-9, reflector coupling assembly 34 includes a reflector cap 134, a hanger cap 136, a reflector cap electrical connector 138, and a hanger cap electrical connector 140. Reflector cap 134 is suitably configured for coupling with a reflector 26 and/or a lampholder 28. Hanger cap 136 is suitably configured for coupling with a distal end of base arm 142. A reflector cap electrical connector 138 is mounted to reflector cap 134 in a suitable manner. Hanger cap electrical connector 140 is mounted to hanger cap 136 in a suitable manner. Reflector cap 134 is mechanically coupled with hanger cap 136 in a suitable manner. Reflector cap electrical connector 138 is directly electrically coupled with hanger cap electrical connector 140.

Reflector cap 134 includes a top member 144 and two opposing brackets 146, 148. Top member 144 is generally planar, has a generally flat expanse 150, and is generally rectangular in shape. Opposing brackets 146, 148 are lampholder bracket 146 and reflector cap electrical connector bracket 148. Each opposing bracket 146, 148 extends in a downward direction from corresponding generally parallel longitudinal edges 152 of top member 144, each opposing bracket 146, 148 being generally perpendicular to top member 144. Reflector cap electrical connector bracket 148 defines a hole where reflector cap electrical connector 138 is mounted in a suitable manner. An end 154 of reflector cap electrical connector 138 facing lampholder bracket 146 includes terminals which mate with terminals (not shown) of conductors from lampholder 28.

Hanger cap 136 includes a top member 156, a cover plate 158, hanger cap electrical connector bracket 160, hanger cap electrical connector 140, a base arm bracket 162 coupled with top member 156, and a flange 164. Top member 156 is generally planar, has a generally flat expanse 166, and defines a hole 168. Hanger cap electrical connector bracket 160 is coupled with and extends in a downward direction from an edge 170 of top member 156 or from an edge 172 of base arm bracket 162. Hanger cap electrical connector bracket 160 is generally perpendicular to top member 156 or base arm bracket 162. Hanger cap electrical connector bracket 160 defines a hole where hanger cap electrical connector 140 is mounted. Base arm bracket 162 has a surface which extends below a plane defined by top member 156. Base arm bracket 162 defines a hole 174. Terminals (not shown) of conductors (not shown) extending from a base arm distal end 142 run through hole 174 to couple with hanger cap electrical connector 140. These base arm distal end 142 terminals (not shown) mate with terminals included on an end 176 of hanger cap electrical connector 140. End 176 faces away from reflector cap 134.

Flange 164 extends downwardly from a top member edge 170 opposite cover plate 158 or from a bottom surface 178 of top member 156 of hanger cap 136. Flange 164 includes a dimple 180. After hanger cap 136 is slid into reflector 26, dimple 180 snaps around reflector cap electrical connector bracket 148 in a suitable manner to mechanically couple, at least in part, reflector cap 134 with hanger cap 136. A fastener, such as a screw (not shown), can also serve to mechanically couple reflector cap 134 with hanger cap 136 in a suitable manner.

Reflector cap electrical connector 138 includes terminals 182 facing and mating with corresponding terminals 184 of hanger cap electrical connector 140. When reflector cap electrical connector 138 and hanger cap electrical connector 140 electrically couple with each other, each has an insertion direction generally parallel to the generally flat expanse 150, 166 of each respective top member 144, 156. Reflector cap electrical connector 138 can include a set of reflector cap electrical connectors, such as two Anderson connectors. Hanger cap electrical connector 140 can include a set of hanger cap electrical connectors, such as two Anderson connectors.

Reflector cap 134 can be mechanically coupled with lampholder 28 by a suitable snap fit configuration. Reflector cap 134 can be mechanically coupled with reflector 26 by fasteners, such as two screws (not shown), in a suitable manner.

To assemble linear light fixture 20, each of the hanger, wireway, and reflector coupling assemblies 30, 32, 34 must be assembled. Regarding hanger coupling assembly 30, conductors (not shown) are routed through vertical arm 38, coupler 46, and base arms 40. Neck 48 of coupler 46 is inserted into vertical arm lower end 42 and secured by frictional engagement, such as by compression and teeth 58. Vertical arm lower end 42 essentially seats on top surface 74 of middle section 72 of base 50. Each base end 52 is inserted into corresponding base arm proximal ends 44 and secured by frictional engagement, such as by compression and teeth 64. If neck 48 and base 50 are separate pieces, before inserting neck 48 into vertical arm lower end 42 fastener 78 is fastened to threaded hole 76 and can be secured against shoulder 84.

Regarding wireway coupling assembly 32, vertical arm upper end 98 is clamped and secured in U-shaped section 100 of vertical arm bracket 90 in a suitable manner. First and second electrical connectors 94, 96 should already be mounted in a suitable manner to vertical arm bracket 90 and wireway bracket 92, respectively. Tabs 104 are inserted through slots 108 from the side of wireway bracket 92 opposite the side of wireway bracket 92 on which second electrical connector 96 is mounted to wireway bracket 92, as shown in FIG. 7. Vertical arm bracket 90 is slid in a downward direction generally parallel to flat expanses 102, 112. In so doing, male terminals 124 of first electrical connector 94 mate with first subset of female terminals 130 of second electrical connector 96, and tabs 104 seat in slots 108. Electrical connection is made between the electrical connector (not shown) rising from vertical arm upper end 98 and female terminals 122 of first electrical connector 94 and between the electrical connector (not shown) virtually exiting wireway 24 and second subset of female terminals 132 of second electrical connector 96. Holes 106, 110 should be essentially aligned. A screw then can be inserted from the vertical arm bracket 90 side of aligned holes 106, 110, through holes 106, 110, to the wireway bracket 92 side of aligned holes 106, 110, and to threaded holes (not shown) on wireway 24 for securing wireway coupling assembly 32 (a second screw can similarly be inserted through the second pair of holes 106, 110). Before tightening the screws, the screws can be slid into the slotted portion of keyhole 106. Thus, during assembly of wireway coupling assembly 32, simultaneous mechanical and electrical coupling of brackets 90 and 92 occurs.

Regarding reflector coupling assembly 34, electrical conductors (not shown) extending from distal end 142 of base arm 40 can be inserted through hole 174 in base arm bracket 162. Distal end 142 of base arm 40 is secured in a suitable manner to base arm bracket 162. An electrical connector (not shown) attached to conductors (not shown) exiting distal end 142 of base arm 40 can be attached to end 176 of hanger cap electrical connector 140, which has already been mounted in a suitable manner on hanger cap electrical connector bracket 160. Reflector cap electrical connector 138 is mounted on reflector cap electrical connector bracket 148 in a suitable manner. Reflector cap 134 can be coupled with lampholder 28 by a suitable snap fit configuration. Electrical connection is made in a suitable manner between the lamp (not shown) and end 154 of reflector cap electrical connector 138. Reflector cap 134 can be coupled with reflector 26 in a suitable manner, such as by two screws. Hanger cap 136 is then slid into grooves in reflector 26 until hanger cap electrical connector 140 mates with reflector cap electrical connector 138, the insertion direction between electrical connectors 138 and 140 being generally parallel to flat expanses 150 and 166. In so doing, dimple 180 snaps around reflector cap electrical connector bracket 148 in a suitable manner. A screw can be used in a suitable manner to further secure coupling between reflector cap 134 and hanger cap 136. Thus, during assembly of reflector coupling assembly 34, simultaneous mechanical and electrical coupling of caps (which can also be generally referred to as “brackets”) 134 and 136 occurs.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A hanger coupling assembly for a light fixture, said hanger coupling assembly comprising:
a vertical arm having a lower end;
a pair of base arms each having a proximal end; and
a coupler including a neck and a base, said base having two ends, said neck frictionally coupled with said lower end of said vertical arm, each said end of said base frictionally coupled with a corresponding said base arm proximal end.

2. The hanger coupling assembly of claim 1, wherein said vertical arm lower end includes an inner surface, said neck includes an outer surface, said frictional coupling of said vertical arm lower end and said neck comprises said inner surface of said vertical arm lower end at least partially circumferentially overlapping said outer surface of said neck.

3. The hanger coupling assembly of claim 2, wherein said outer surface of said neck includes teeth.

4. The hanger assembly of claim 1, wherein each said base arm proximal end includes an inner surface, each said base end includes an outer surface, said frictional coupling of said base ends with said corresponding base arm proximal ends comprises said inner surface of each said base arm proximal end circumferentially overlapping said outer surface of each said base end.

5. The hanger coupling assembly of claim 4, wherein said outer surface of each said base end includes teeth.

6. The hanger coupling assembly of claim 1, wherein said neck and said base are attachable and detachable relative to one another.

7. The hanger coupling assembly of claim 6, further comprising a fastener, wherein said base includes a middle section, said middle section having a top surface and defining a threaded hole in said top surface, said neck defining a hollow chamber, said neck connected to said top surface of said middle section of said base by said fastener fastened to said threaded hole through said hollow chamber.

8. The hanger coupling assembly of claim 7, wherein said hollow chamber includes a shoulder, said fastener mounted on said shoulder of said hollow chamber.

9. The hanger coupling assembly of claim 1, wherein each said base end has a smaller radial cross-section than a radial cross-section of said middle section of said base.

10. The hanger coupling assembly of claim 1, wherein said neck of said coupler being vertically oriented, said base of said coupler being one of generally horizontally oriented and downwardly arced.

11. The hanger coupling assembly of claim 1, wherein said base arms extend from said coupler in a downwardly arced direction.

12. A wireway coupling assembly of a light fixture having a vertical arm, said wireway coupling assembly comprising:
a vertical arm bracket configured for coupling with the vertical arm;
a first electrical connector mounted to said vertical arm bracket;
a wireway bracket mechanically coupled with said vertical arm bracket; and
a second electrical connector mounted to said wireway bracket, said second electrical connector directly electrically coupled with said first electrical connector.

13. The wireway coupling assembly of claim 12, wherein said first electrical connector is riveted to said vertical arm bracket, said second electrical connector is riveted to said wireway bracket.

14. The wireway coupling assembly of claim 12, wherein said first electrical connector comprises a first plurality of terminals including at least one of a first plurality of male terminals and a first plurality of female terminals, said second electrical connector comprises a second plurality of terminals including at least one of a second plurality of male terminals and a second plurality of female terminals.

15. A reflector coupling assembly for a light fixture having a reflector and a lampholder, said reflector coupling assembly comprising:
a reflector cap configured for coupling with at least one of the reflector and the lampholder;
a hanger cap coupled with said reflector cap, said hanger cap configured for coupling with an end of a base arm;
at least one reflector cap electrical connector mounted to said reflector cap; and
at least one hanger cap electrical connector mounted to said hanger cap, each said hanger cap electrical connector directly electrically coupled with a corresponding said reflector cap electrical connector.

16. The reflector coupling assembly of claim 15, wherein said reflector cap comprises a top member and at least one bracket, said top member being generally planar, said at least one bracket extending in a downward direction from said top member, said reflector cap electrical connector mounted to said at least one bracket.

17. The reflector coupling assembly of claim 15, wherein said hanger cap comprises a top member, a base arm bracket coupled with said top member, and an electrical connector bracket coupled with and extending in a downward direction from one of said top member and said base arm bracket, said hanger cap electrical connector mounted to said electrical connector bracket.

18. The reflector coupling assembly of claim 15, wherein said at least one reflector cap electrical connector includes a plurality of reflector cap electrical connectors, said at least one hanger cap electrical connector includes a plurality of hanger cap electrical connectors.

19. The reflector coupling assembly of claim 15, wherein said reflector cap comprises a bracket, said hanger cap includes a flange having a dimple, said dimple coupled with said reflector cap bracket.

20. The reflector coupling assembly of claim 15, further comprising an end of the reflector, wherein said reflector cap coupled with said end of the reflector.

21. The reflector coupling assembly of claim 15, wherein said reflector cap coupled with the lampholder.

22. A mechanical and electrical coupling assembly for a light fixture, said coupling assembly comprising:
a first bracket configured for coupling with an end of a support arm;
a first electrical connector mounted to said first bracket;
a second bracket mechanically coupled with said first bracket; and
a second electrical connector mounted to said second bracket, said second electrical connector directly electrically coupled with said first electrical connector.

23. The light fixture of claim 22, wherein said first bracket comprises a vertical arm bracket and said second bracket comprises a wireway bracket.

24. The light fixture of claim 22, wherein said first bracket comprises a hanger cap and said second bracket comprises a reflector cap.

25. The light fixture of claim 22, wherein each of said first bracket and said second bracket have a generally flat expanse, and said first electrical connector and said second electrical connector have an insertion direction generally parallel to said flat expanse.
